(19) United States
(12) Patent Application Publication
(10) Pub. No.: US 2026/0249256 A1
(43) Pub. Date: Aug. 27, 2026

(54) BEVERAGE CONTAINER WITH CARBONATING LID

(71) Applicant: Brumis Imports Inc., New York, NY (US)

(72) Inventors: Sean Fogarty, Huntington, NY (US); Sahir Sagar, Brooklyn, NY (US); Nina Zheng, Brooklyn, NY (US); Steven Bram, New York, NY (US)

(21) Appl. No.: 19/548,544

(22) Filed: Feb. 24, 2026

Related U.S. Application Data
(60) Provisional application No. 63/762,411, filed on Feb. 24, 2025.

(51) Int. Cl. B01F 23/2361; A47G 19/22; B01F 23/236; B01F 23/237; B01F 35/60; B65D 47/12; B65D 51/16; B65D 51/24; B65D 51/28; B65D 53/02; B01F 101/14

(52) U.S. Cl. CPC B01F 23/23611; A47G 19/2272; B01F 23/2364; B01F 23/237621; B01F 35/602; B65D 47/122; B65D 51/1688; B65D 51/242; B65D 51/2807; B65D 53/02; B01F 2101/14

(57) ABSTRACT

A beverage container includes a removable lid that is operable to carbonate a liquid in the container. In particular, the lid may include a cartridge portion that includes a cartridge including a compresses gas that may be selectively activated to provide gas to the liquid in the container.

### CROSS-REFERENCE TO RELATED APPLICATIONS

The present application claims benefit of and priority to U.S. Provisional Patent Application No. 63/762,411 entitled BEVERAGE CONTAINER WITH CARBONATING LID filed Feb. 24, 2025, the entire content of which is hereby incorporated by reference herein.

### BACKGROUND

### Field

The present application relates to a reusable beverage container that includes a lid or cover that may be used to provide carbonization to the liquid in the container. The lid receives a carbon dioxide cartridge mounted therein and is configured to selectively release carbon dioxide into the liquid in the container to provide a carbonated liquid. The carbon dioxide cartridge may be used multiple times and may be replaced when empty. In embodiments, the cartridge may be used to introduce other gases into the beverage.

### Related Art

Carbonated water and other beverages have become popular. There are a number of systems that can be used to provide carbonated beverages via a dispensing apparatus. In such devices, the dispensing apparatus is separate from the container from which the beverage is consumed and dispenses the carbonated beverage into a container for drinking. Such carbonation systems, however, are not portable and are inconvenient in that they require multiple pieces of equipment.

There are containers from which a beverage can be consumed from that also allow for carbonation of the beverage. In some such containers, the container includes a base in which a pressurized cartridge is mounted. The cartridge triggered to release gas into the container, and the liquid beverage contained therein to carbonate the beverage. Such devices, however, are single use devices in which activation of the cartridge releases all of the carbon dioxide therein into the liquid at the same time. Further, in such devices, since the cartridge is mounted in the base of the container, it adds weight and takes up usable volume that could be used for the beverage. Further, in such one-use devices, if the container is refilled with liquid, there is no longer any gas left in the base to carbonate it.

Accordingly, it would be beneficial to provide a beverage container that provides carbonated beverages and avoids the above problems.

### SUMMARY

A beverage container in accordance with an embodiment of the present disclosure includes a lid with a pressurized gas cartridge that may be discharged multiple times to carbonate a liquid in the beverage container.

A beverage container in accordance with an embodiment of the present disclosure includes: a container portion including a hollow body configured to receive a beverage and including an open top; a lid removably secured to the open top of the container portion; the lid including: a drink opening formed in a top surface thereof and in fluid communication with the hollow body; a pressure relief valve mounted in the lid and configured to vent pressure when a pressure in the hollow body exceeds a threshold; a cartridge portion extending downward from the lid into the container, the cartridge portion including a cartridge including a compressed gas; a lever pivotally mounted on a top surface of the lid movable about a pivot pin from a raised position to a lowered position, such that the cartridge is moved downward when the lever is pivoted to the lowered position, wherein the cartridge portion further includes: a first valve in contact with a bottom of the cartridge including a fixed element that engages a bottom end of the cartridge to release compressed gas from the cartridge as the cartridge is moved down by the plunger; and a second valve positioned downstream from the first valve configured to selectively release compressed air into the container from the first valve to pressurize the hollow chamber.

In embodiments, the pressure relief valve is movably mounted in the drink opening to prevent drinking in a closed position and movable to an open position, removed from the drink opening, when in an open position.

In embodiments, the pressure relief valve further includes: a base with a first opening formed in a bottom surface thereof and in fluid communication with the hollow body; a movable element mounted in the base and movable from a sealed position where the movable element closes the first opening to an unsealed position where the movable element allows air to move from the hollow portion into the pressure relief valve; a second opening formed is an upper portion of the base in fluid communication with an exterior such that gas from the hollow chamber that enters the first opening exits the pressure relief valve; wherein the movable member is biased into a sealed position and the movable member moves upward to allow gas to exit the container when a pressure in the hollow chamber exceeds a threshold; and a third set of threads formed on an outer surface of a lower portion of base configured to secure the pressure relief valve in the drink opening in the closed position and to remove the pressure relief valve from the drink opening when in the open position.

In embodiments, the lever is operably connected to a plunger that contacts the cartridge to push the cartridge down when the lever is pivoted to the lowered position.

In embodiments, the lid includes a first set of threads provided on an inner surface of a peripheral flange that interact with a second set of threads provided on an outer surface of a top portion of the container portion to selectively secure the lid to the container portion when the lever is pivoted to the lowered position.

In embodiments, the lid includes a movable cover configured to receive the pressure relief valve and movable from a closed position, where the pressure relief valve is positioned in the drinking opening and an open position where the pressure relief valve is removed from the drinking opening.

In embodiments, the third set of threads include gaps formed in the threads to allow gas to escape from the hollow chamber as the pressure relief valve is removed from the drink opening.

In embodiments, at least one edge of the third set of threads is rounded.

In embodiments, the first valve includes: a support element in contact with the cartridge; a biasing element configured to bias the support into a raised position, wherein the support element and cartridge move down when the lever is depressed.

In embodiments, the fixed element is mounted in the support such that the fixed element is in contact with a cartridge valve provided in the cartridge.

In embodiments, the beverage container includes a flow path formed in the fixed element configured to provide gas from the cartridge to the second valve.

In embodiments, the beverage container includes a manifold provided downstream of the flow path configured to receive compressed air from the cartridge.

In embodiments, the second valve includes a hollow post provided at a bottom portion thereof including openings formed in a sidewall thereof and a cylindrical flexible seal covering the openings formed in the sidewall, wherein the seal cylindrical seal flexes outward to allow gas to exit the second valve when pressure in the post exceeds a threshold.

In embodiments, the cylindrical seal is made of silicone.

In embodiments, the beverage container includes a handle pivotally attached to the lid.

In embodiments, the second valve is a ball valve.

In embodiments, the pressure relief valve includes a first seal provided at a bottom of the base preventing air from passing between the base and the drink opening.

In embodiments, the pressure relief valve includes a second seal preventing gas from passing into a top of the pressure relief valve.

A lid for a beverage container in accordance with an embodiment of the present disclosure includes: a drink opening formed in a top surface thereof; a pressure relief valve removably mounted in the lid and configured to vent gas when a pressure in the container exceeds a threshold; a cartridge portion extending downward from the lid into the container, the cartridge portion including a cartridge including a compressed gas; a lever pivotally mounted on a top surface of the lid movable about a pivot pin from a raised position to a lowered position, when the level is pivoted to the lowered position, wherein the cartridge portion further includes: a first valve in contact with a bottom of the cartridge including a fixed element that engages a bottom end of the cartridge to release compressed gas from the cartridge as the cartridge is moved down by the plunger; and a second valve positioned downstream from the first valve configured to selectively release compressed air into the container from the first valve to pressurize the hollow chamber.

In embodiments, the pressure relief valve closes the drink opening to prevent drinking in a closed position and is movable to an open position, removed from the drink opening when in an open position.

In embodiments, the pressure relief valve includes: a base with a first opening formed in a bottom surface thereof and in fluid communication with the hollow body; a movable element mounted in the base and movable from a sealed position where the movable element closes the first opening to an unsealed position where the movable element allows air to move into the pressure relief valve; a second opening formed is an upper portion of the base in fluid communication with an exterior such that gas that enters the first opening exits the pressure relief valve; wherein the movable member is biased into a sealed position and the movable member moves upward to allow gas to exit when a pressure in the hollow chamber exceeds a threshold; and a third set of threads formed on an outer surface of a lower portion of base configured to secure the pressure relief valve in the drink opening in the closed position and to remove the pressure relief valve from the drink opening when in the open position.

In embodiments, the lever is operably connected to a plunger that contacts the cartridge such that the cartridge is moved downward when the lever is pivoted into the lowered position.

In embodiments, the lid includes a movable cover configured to receive the pressure relief valve and movable from a closed position, where the pressure relief valve is positioned in the drinking opening and an open position where the pressure relief valve is removed from the drinking opening.

In embodiments, the third set of threads include gaps formed in the threads to allow gas to escape from the hollow chamber as the pressure relief valve is removed from the drink opening.

In embodiments, at least one edge of the third set of threads is rounded.

In embodiments, the first valve includes: a support element in contact with the cartridge; and a biasing element configured to bias the support into a raised position, wherein the support element and cartridge move down when the lever is depressed.

### BRIEF DESCRIPTION OF THE DRAWINGS

FIG. 1 illustrates a beverage container and lid in accordance with an embodiment of the present disclosure;

FIG. 2A illustrates a more detailed view of the lid of the beverage container in FIG. 1 in accordance with an embodiment of the present disclosure;

FIG. 2B illustrates a cross-section of the lid of the beverage container in FIG. 1 in accordance with an embodiment of the present disclosure;

FIG. 3A illustrates a side view of the lid of FIG. 2A along the line A in accordance with an embodiment of the present disclosure;

FIG. 3B illustrates a cross-section of the relief valve mountable in the lid of FIGS. 2A and 2B in accordance with an embodiment of the present disclosure;

FIG. 3C is a perspective view of the relief valve mountable in the lid of FIGS. 2A and 2B in accordance with an embodiment of the present disclosure;

FIG. 3D is a perspective view of a relief valve mountable in the lid in accordance with another embodiment of the present disclosure;

FIG. 3E illustrates a side view of the lid relief valve in FIG. 3D in accordance with an embodiment of the present disclosure;

FIG. 3F illustrates a cross-section of the lid relief valve in FIG. 3D in accordance with an embodiment of the present disclosure;

FIG. 3G illustrates a bottom view of the lid relief valve in FIG. 3D in accordance with an embodiment of the present disclosure;

FIG. 4 illustrates a cross section of the beverage container of FIG. 1 in accordance with an embodiment of the present disclosure;

FIG. 5 illustrates a detailed view of an interface of the cartridge and a cartridge receiving compartment of the beverage container in an open position in which gas is escaping the cartridge into the cartridge receiving compartment and into the container body in accordance with an embodiment of the present disclosure;

FIG. 6 illustrates a detailed view of the interface of the cartridge receiving compartment of the beverage container in a closed position in which gas is prevented from escaping the cartridge into the cartridge receiving compartment and into the container body in accordance with an embodiment of the present disclosure; and

FIG. 7 illustrates a detailed view of the interface of the cartridge receiving compartment of the beverage container in a closed position in which gas is prevented from escaping the cartridge into the cartridge receiving compartment and into the container body in accordance with an embodiment of the present disclosure;

FIG. 8 illustrates a cross-section of the interface of the cartridge receiving compartment cartridge in accordance with another embodiment of the present disclosure;

FIG. 9 illustrates a cross-section of the cartridge receiving compartment of FIG. 8 in accordance with another embodiment of the present disclosure;

FIG. 10 illustrates a beverage container and lid using the cartridge receiving compartment of FIG. 8 in accordance with another embodiment of the present disclosure;

FIG. 11 illustrates a cross-section of the beverage container of FIG. 10 in accordance with another embodiment of the present disclosure;

FIG. 12 illustrates a more detailed view of the cross-section of the lid of the beverage container of FIG. 11 in accordance with another embodiment of the present disclosure;

FIG. 13 illustrates a cross-section of the lid of FIG. 10 showing a lock that can be used to lock the lever and prevent discharge of gas in accordance with an embodiment, of the present disclosure with the lock in a locked position;

FIG. 14 illustrates a cross-section of FIG. 13 showing a lock mechanism that can be used to lock the lever and prevent discharge of gas in accordance with an embodiment, of the present disclosure with the lock in an unlocked position; and

FIG. 15 illustrates a more detailed view of the lid of FIG. 10 including the lock with the cover in the closer position in accordance with an embodiment, of the present disclosure with the lock in an unlocked position.

### DESCRIPTION OF THE EMBODIMENTS

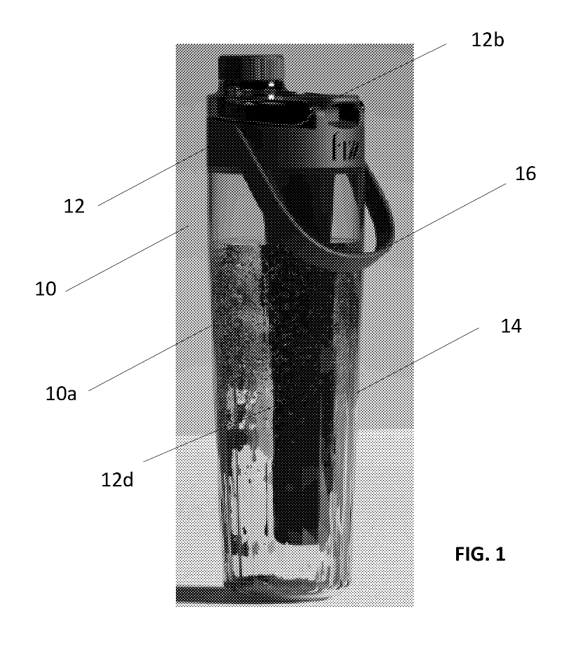

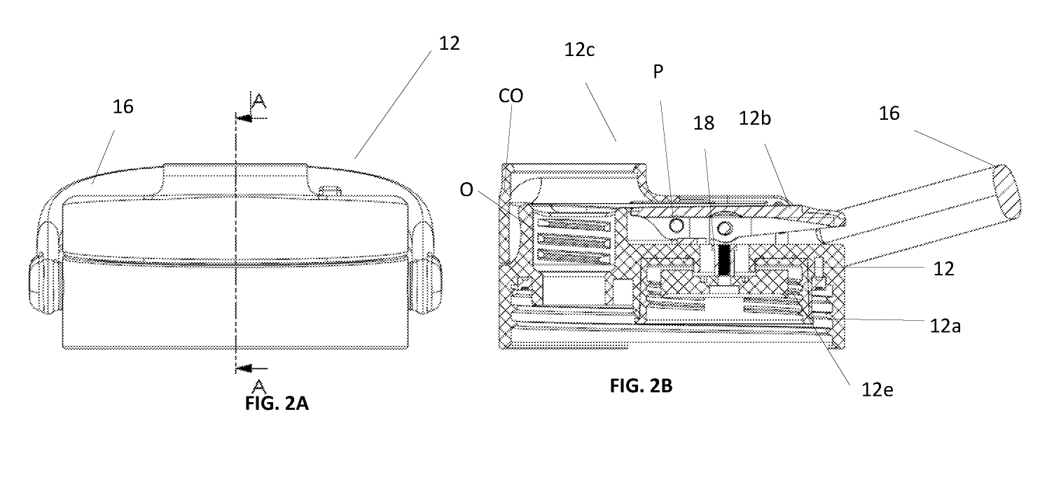

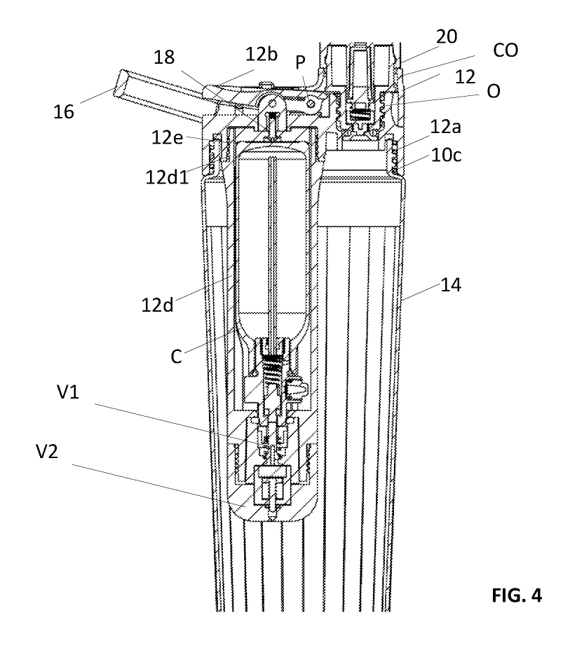

FIG. 1 illustrates a beverage container 10 including a lid 12 that provides carbonation of a fluid provided in the container 10. In embodiments, the lid 12 is removably attached to an open end of the container body 14. In embodiments, the lid 12 may include inward facing threads 12a (see FIG. 2B for example) that may interact with threads 10c (see FIG. 4, for example) provided around the open end of the container body 14 to secure the lid 12 to the container body. In embodiments, any suitable mechanism may be used to removably secure the lid 12 to the container body 14.

In embodiments, when the lid 12 is mounted on the container body 14, a cartridge portion 12d extends into the container body 14. In embodiments, a carbon dioxide cartridge C (see FIG. 4) may be mounted in the cartridge portion 12d. As can be seen in FIG. 4, the cartridge portion 12d extends downward into the container body 14 such that distal end thereof is in the liquid. In embodiments, the cartridge portion 12d may be removably secured to the lid 12 such that the cartridge C may be replaced when empty. In embodiments, the top end of the cartridge portion 12d may include threads 12d1 that interact with threads 12e formed on the lid 12 to removably secure the cartridge portion 12d to the rest of the lid 12. In embodiments, any suitable connection or securing element may be used to removably connect the cartridge portion 12d to the lid 12. In embodiments, the cartridge C includes carbon dioxide, but may include another gas and is moveably mounted within the cartridge portion 12d. In embodiments, to release carbon dioxide, or another gas, into the liquid, the cartridge C is pressed downward, using the lever 12b for example, provided on the lid 12.

In embodiments, the lid 12 includes the lever 12b pivotally mounted on a top thereof. In embodiments, a handle 16 may also be pivotally attached to the lid 12. In embodiments, the lever 12b is connected to the lid 12 via a pivot pin P (see FIG. 2B) and pivots about the pin P. In embodiments, the lever 12b may be attached to a plunger 18 which is in contact with an end of the cartridge C (see FIG. 4, for example). In embodiments, when the lever 12b is pressed downward, the plunger 18 pushes the cartridge C down to release carbon dioxide, or another gas, as is described further below. In embodiments, the cartridge C and the lever 12b are both biased in a raised position such that once the lever is released, the cartridge C and the lever 12b return to the raised position where the gas remains in the cartridge C.

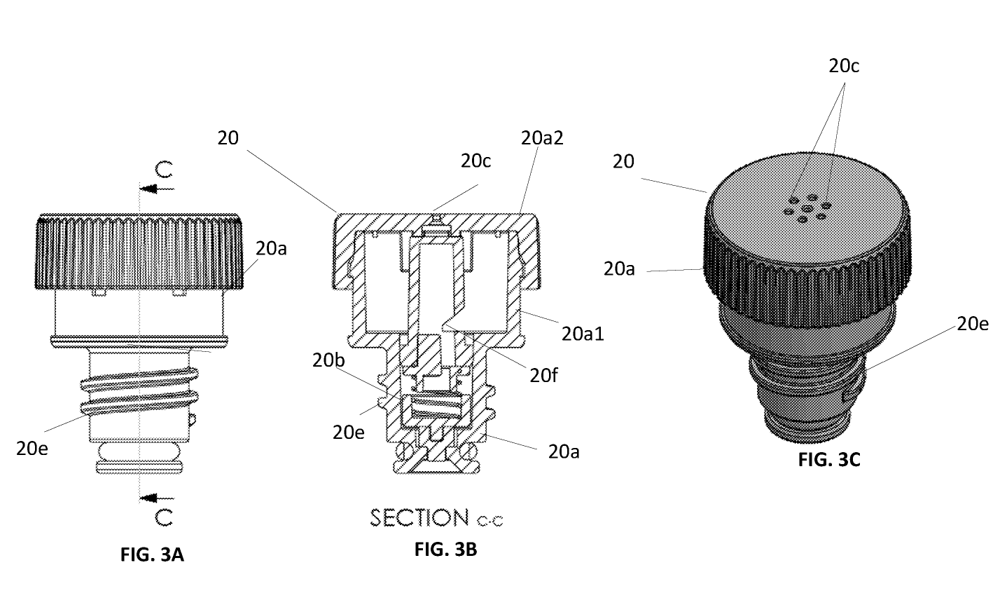

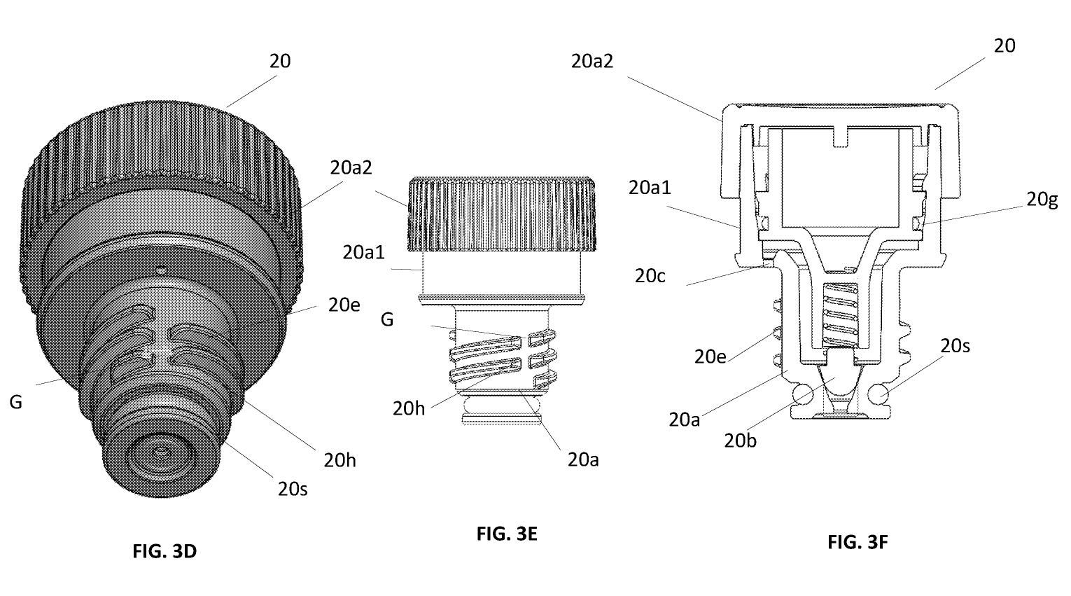

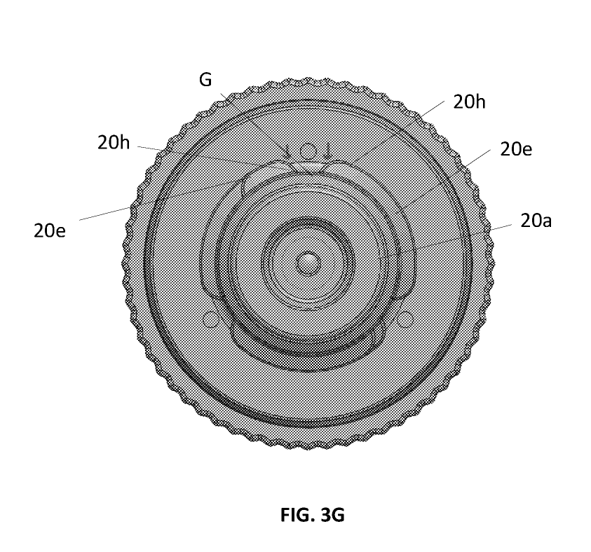

In embodiments, the lid 12 includes a relief valve 20. In embodiments, the relief valve 20 is mounted in the lid 12 and prevents excessive pressure from building in the container body 14 (See FIG. 4, for example). In embodiments, the relief valve 20 may include a body 20a that is secured in the lid 12. In embodiments, the body 20a (see FIG. 3B) may include a base 12a1 and a top 12a2 that may be secured to the top, via a snap fit or any other suitable connection. In embodiments, the valve 20 may be secured in the lid 12 via threads 20e formed on an outer surface of the body 20a that interact with threads 12e formed on the lid to secure the valve 20 in place. In embodiments, the threads 20e may include gaps G (see FIG. 3D and 3E, for example) in the threads which allow for release of small amounts of gas as the valve 20 is turned to allow for a slow release of pressure, if desired. In embodiments, any suitable fastening element may be used to connect the valve 20 to the lid 12. In embodiments, a movable element 20b is mounted in the body 20a at a bottom end thereof. The movable element 20b is biased into a closed position in which it keeps carbon dioxide or another gas in the body 14. In embodiments, when the pressure in the container body 14 exceeds a threshold value, the movable body 20b moves upward to allow carbon dioxide to exit the container body 14. In embodiments, the carbon dioxide (or other gas) may pass through a whistle opening 20f (FIG. 3B), resulting in an audible sound to notify a user that the threshold pressure has been met or exceeded in the container body 10a. In embodiments, the air passes out of the valve 20 via the openings 20c at the top. In embodiments, the whistle opening 20f may not be included, for example, as indicated in FIGS. 3D and 3E and the gas may pass through the valve 20 without a whistle sound.

As noted above, the threads 20e may include spaces or gaps G to allow for venting of gases as the valve 20 is opened as can be seen in FIGS. 3D and 3G. In embodiments, the ends 20h of the threads 20e are rounded to prevent whistling as the air passes through the gaps G. In FIGS. 3D and 3G, the arrows highlight these rounded edges In embodiments, the movable element 20b may have a conical shape to provide for a more consistent seal at the bottom of the valve 20. As noted above, the movable element 20b is biased into a closed/lower position but will move upward when pressure in the container 14 exceeds a threshold. Once the movable element 20b moves upward, the gas from the container travels upward and out the opening 20c formed in a bottom surface of the based 20a1. In this embodiment, the air exiting the opening 20c provides an audible indication when the air rushes out onto the lid 12 alerting the user to opening of the release valve 20. In embodiments, the top of the valve 20 is sealed off using the seals 20g. In embodiments, a seal 20s is also provided at a base of the valve 20 to prevent gas from escaping around the body of the valve 20.

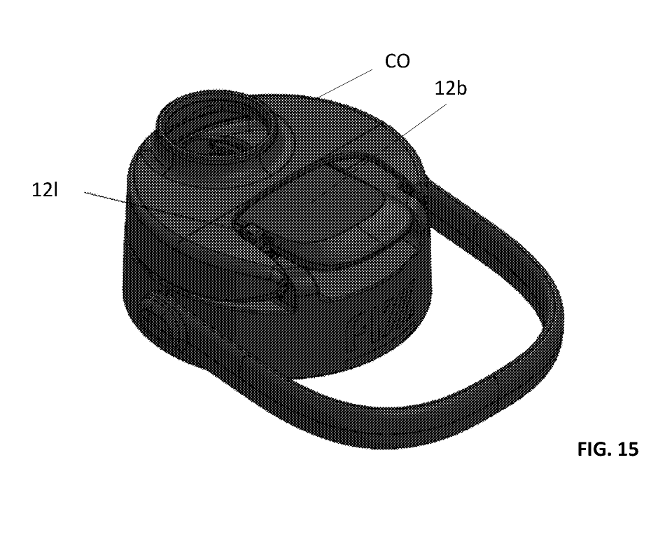

In embodiments, the relief valve 20 may be mounted in the drinking opening O provided in the lid 12. In embodiments, a cover CO ( FIGS. 10-11 and 15) is rotatably mounted on the lid 12 to move between a closed position in which the valve 20 is mounted in the drinking opening O and prevents consumption of the beverage. The cover CO is rotatable to an open position wherein the valve 20 is removed from the opening O. In embodiments, the valve 20 is rotated to release pressure before the cover CO is opened to allow the user to drink through opening O. In embodiments, the opening O may include internal threads that secure the valve 20 to the lid 12 when in the closed position.

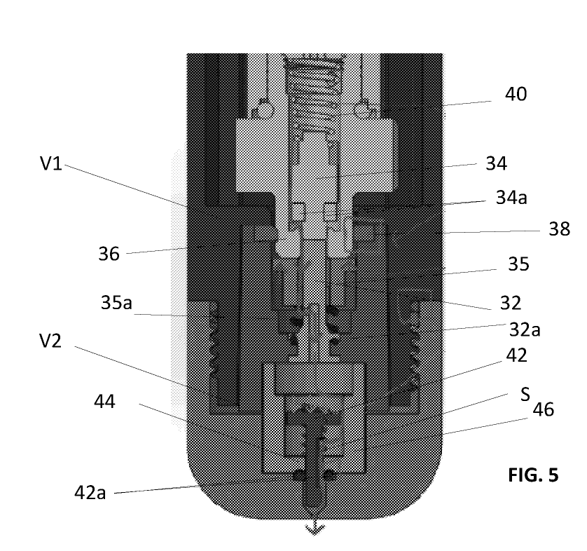

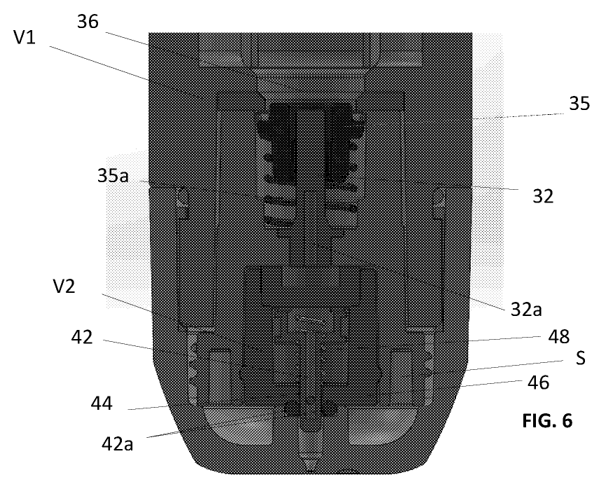

In embodiments, the cartridge C includes a valve V1 at a distal end thereof that releases the carbon dioxide, or other gas, from the cartridge C. In embodiments, when a user pushes down on the lever 12b, the cartridge C is moved down by plunger 18. A support 35 in the cartridge portion 12d is biased to hold the cartridge C in a raised position, as indicated in FIG. 6, for example where the biasing element 35a holds the support 35 in a raised position and supports the cartridge C in the raised position. When pressure is provided on the lever 12b, the cartridge C is moved down and the biasing force of the biasing element 35a is overcome such that the support 35 is pushed down with the cartridge, as indicated in FIG. 5. In embodiments, a pin 32 is mounted in the bottom of the cartridge compartment 12d that pushes up on a movable member 34 of the cartridge as the cartridge C moves downward. The upward movement separates the movable member 34 from the seat 36 to provide a space through which carbon dioxide, or another gas, may pass out of the cartridge C. In a closed position, as indicated in FIG. 6, for example, the inner seal 34a of the movable member 34 prevents gas from flowing between the movable member 34 and the seat 36. As the movable member 34 moves upward, the seal 34a is separated from the seat 36 and gas flows into this space. In embodiments, a seal 38 may be provided around the seat 36 to ensure that released gas does not escape from the cartridge C upward in FIG. 5, for example. In embodiments, the pin 32 includes a hollow flow path 32a at a bottom thereof to allow the flow of carbon dioxide, or other gas, that flows around the top of the pin 32 to enter the flow path as indicated by the arrows in FIG. 5.

In embodiments, the movable member 34 is biased into the closed position using biasing element 34a in which escape of carbon dioxide from the cartridge C is prevented. The pressure applied when the lever 12b is depressed moves the cartridge C down such that the pin 32 pushes up on the movable member 34. The gas moves around the moveable member 34 as indicated by the arrows in FIG. 5 around the top of the pin 32 and then into the hollow flowpath 32a provided at the base of the pin 32. The gas then passes into a second valve V2 provided at the distal end of the cartridge portion 12d.

The pressure of the gas pushes a second movable member 42 down as indicated in FIG. 5. The second movable member 42 includes a slot S formed in an upper portion thereof such that as the moveable member 42 moves down, the slot moves into alignment with the opening 44 formed in the bottom of the seat 46 thereof such that gas flows through the slot and the opening 44 and out of the cartridge portion 12d. The second movable member 42 is biased into a closed position (see FIG. 6) where the slot S is not aligned with the opening 44 to prevent gas from exiting the cartridge portion 12d. A biasing element 48 is used to bias the second movable member 42 into the closed position (FIG. 6). In the closed position, the second movable member 42 prevents gas from escaping into the container body 10a and also prevents liquid from entering the valve V2 as can be seen in FIG. 6. A seal 42a may be provided around the bottom of the member 42 in the opening 44 to prevent leakage of gas out and water in.

The second valve V2 allows the gas from cartridge C to pass out of the cartridge portion 12d and into the liquid in the container body 12a. In embodiments, as noted above, the gas only escapes when the lever 12b is pressed downward, otherwise, the cartridge C is biased into a raised position and the valves V1 and V2 are closed to prevent gas from entering the container body 12a. Thus, gas may be selectively released from the cartridge C to carbonate the liquid in the container body 10a. This allows the cartridge to be used repeatedly over a period of time since not all of the gas is released at once. In embodiments, as noted above, in the event that there is no longer any gas in the cartridge C, the cartridge portion 12d may be removed from the lid 12 and a new cartridge may be provided.

FIG. 6 illustrates an alternate embodiment of the valve V2. In FIG. 6, the second movable member 42 includes the slot S formed in an upper portion thereof such that, as the moveable member 42 moves down, the slot moves into alignment with the opening 44 formed in the bottom of the seat 46 thereof such that gas flows through the slot and the opening 44 and out of the cartridge portion 12d. The second movable member 42 is biased into a closed position (see FIG. 6) where the slot S is not aligned with the opening 44 to prevent gas from exiting the cartridge portion 12d. Biasing element 48 biases the second movable member 42 into the closed position of FIG. 6. In embodiments, in the closed position, the second movable member 42 prevents gas from escaping into the container body 10a and also prevents liquid from entering the valve V2 as can be seen in FIG. 6. A seal 42a may be provided around the bottom of the member 42 in the opening 44 to prevent leakage of gas out and water in.

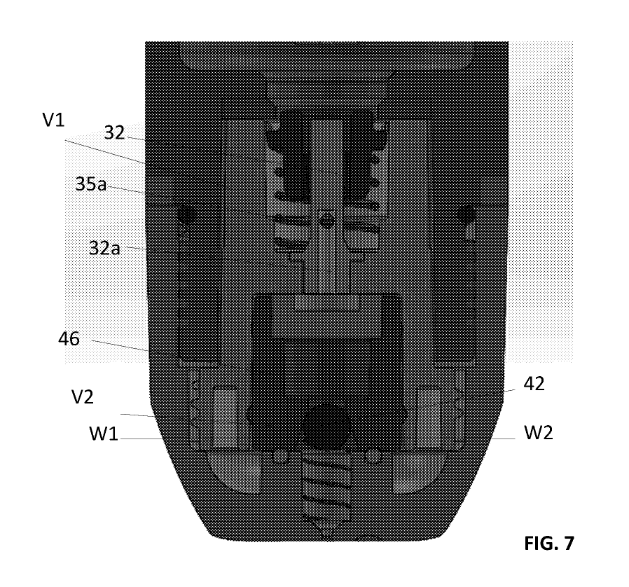

FIG. 7 illustrates another alternate embodiment of the valve V2. In FIG. 7, the second movable member 42 is implemented as a ball in a ball valve. In embodiments, the second movable member moves down as air escapes valve V1 such that the movable member 42 moves down to allow air to pass around the ball along the angled walls W1, W2 in the opening at the bottom of the seat 46 such that gas flows out of the cartridge portion 12d. The second movable member 42 is biased into a closed position (see FIG. 7) by upward pressure of the liquid in the container to prevent fluid from advancing further into the cartridge portion 12d.

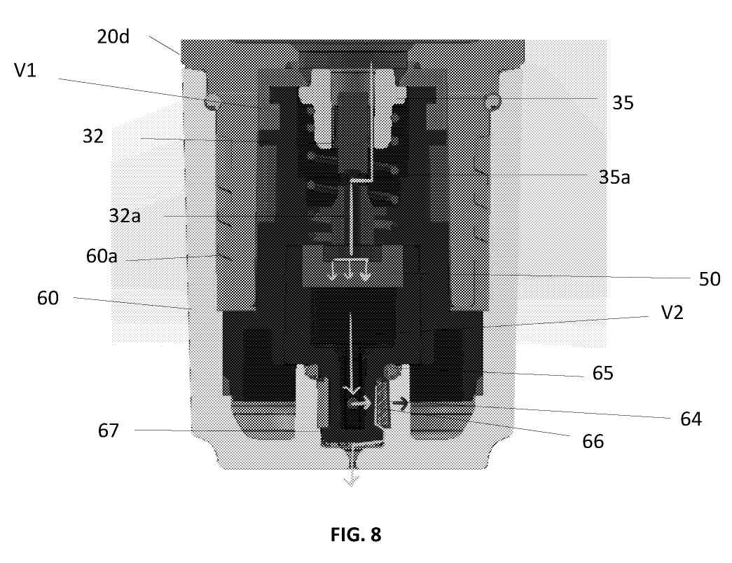

FIG. 8 illustrates another embodiment of the valve V1 and the valve V2. In embodiments, the valve V1 releases the carbon dioxide, or other gas, form the cartridge C. In embodiments, when a user pushed down on the lever 12b, the cartridge C is moved down. A support 35 in the cartridge portion 12d is biased to hold the cartridge C in a raised position, as indicated in FIG. 6, for example where the biasing element 35a holds the support 35 in a raised position and supports the cartridge C in the raised position. When pressure is provided on the lever 12b, the cartridge C is moved down and the biasing force of the biasing element 35a is overcome such that the support 35 is pushed down with the cartridge, as indicated in FIG. 5. In embodiments, a pin 32 is mounted in the bottom of the cartridge body 12d that pushes up on a movable member 34 as the cartridge C moves downward. The upward movement separates the movable member 34 from the seat 36 to provide a space through which carbon dioxide, or another gas, may pass out of the cartridge C. In a closed position, as indicated in FIG. 6, for example, the inner seal 34a of the movable member 34 prevents gas from flowing between the movable member 34 and the seat 36. As the movable member 34 moves upward, the seal 34a is separated from the seat 36 and gas flows into this space. In embodiments, a seal 38 may be provided around the seat 36 to ensure that released gas does not escape from the cartridge C upward in FIG. 5, for example.

In embodiments, the pin 32 includes a hollow flow path 32a at a bottom thereof to allow the flow of carbon dioxide, or other gas, that flows around the top of the pin 32 to enter the flow path as indicated by the arrows in FIG. 8. Thereafter, the gas flows through a manifold 50 toward a bottom of the cartridge portion 12d. In embodiments, the bottom of the cartridge portion 60 is secured to upper portion 12d via the threads 60a. In embodiments, a seal 62 is provided between the lower cartridge portion 60 and the upper portion 12d. A second seal 65 is provided around opening 66 positioned downstream of the manifold 50. When pressure downstream of the manifold 50 exceeds a threshold, the seal 64 expands radially outward to allow gas to exit the cartridge portion 12d out the bottom. The seal 64 may be made of silicone and may flex outward to release gas. After the gas is released, the seal 64 contracts to seal the cartridge portion 12d. In embodiments, the opening 66 is formed in a side of post 67 that extends from the bottom surface of the cartridge portion 60. The gas then exits out the bottom of the lower cartridge portion 60 as indicated by the arrows in FIG. 8.

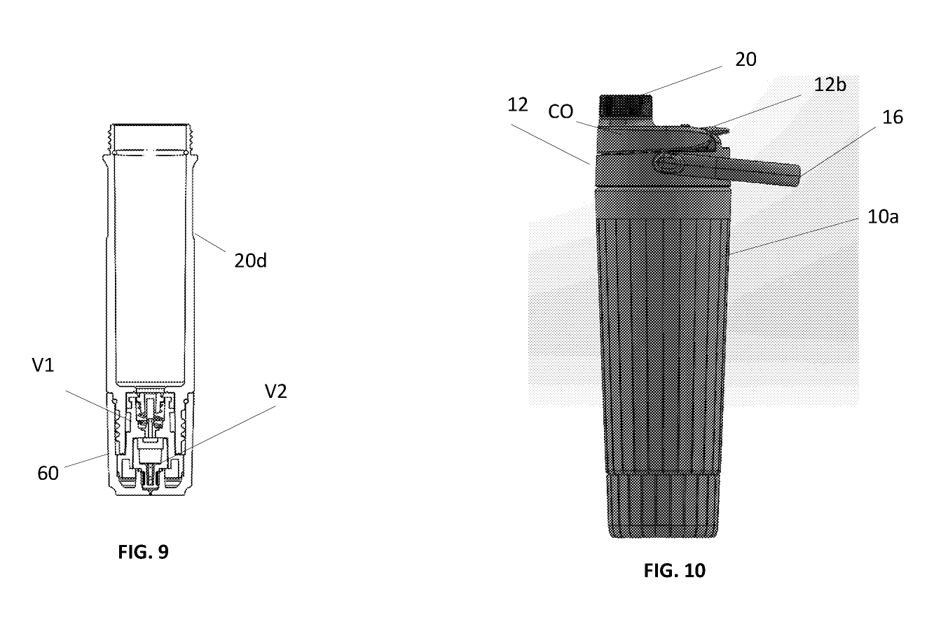

FIG. 9 illustrates a cross-section of the cartridge compartment 20 d including the bottom portion 60 without a cartridge C mounted therein. FIG. 10 illustrates an exemplary beverage container 10’ that is suitable for use with the cartridge compartment 20d shown in FIGS. 8-9. The container 10’ may also be used as the container 10 in FIG. 1.

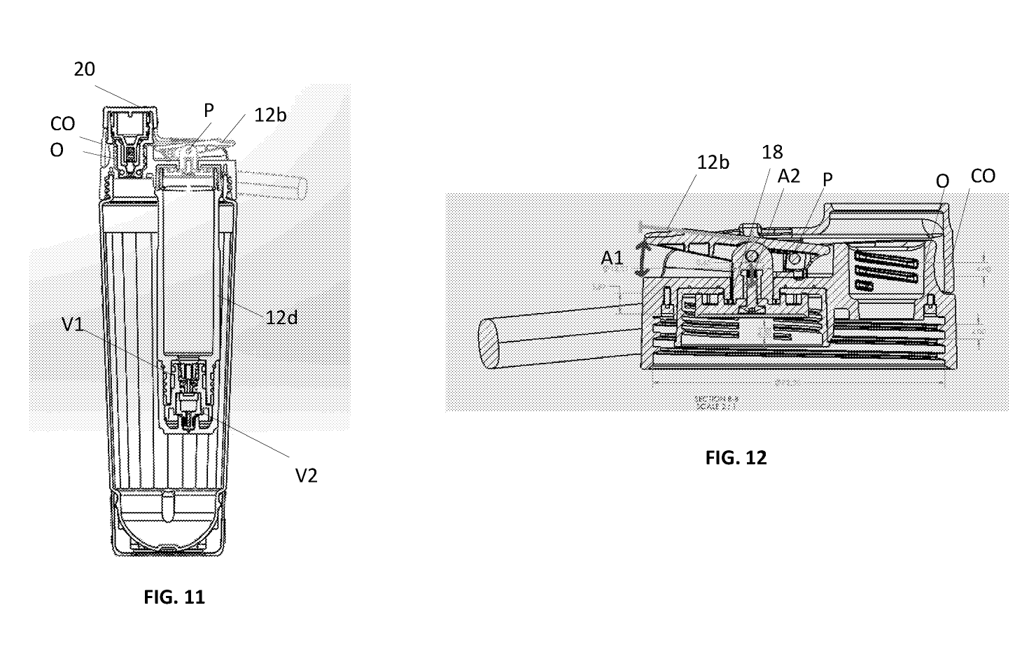

FIG. 11 illustrates a cross-section of the container 10, without the cartridge C mounted in the cartridge portion 20d. FIG. 12 illustrates a more detailed cross-section of the lid 12 highlighting movement of the lever 12b which pivots around pivot pin P to press down using the plunger 10 on the cartridge C. The arrow A1 in FIG. 12 indicates the pivot arc of the lever 12b and arrow A2 indicates the downward movement of the plunger when the lever 12b is pushed downward. As noted above, the downward movement of the plunger 18 pushes the cartridges downward to release gas via the valve V1 discussed above with respect to FIG. 8. It is noted that any of the valve configuration illustrated in FIGS. 5, 6 or7 may also be used. With the lid of FIG. 12.

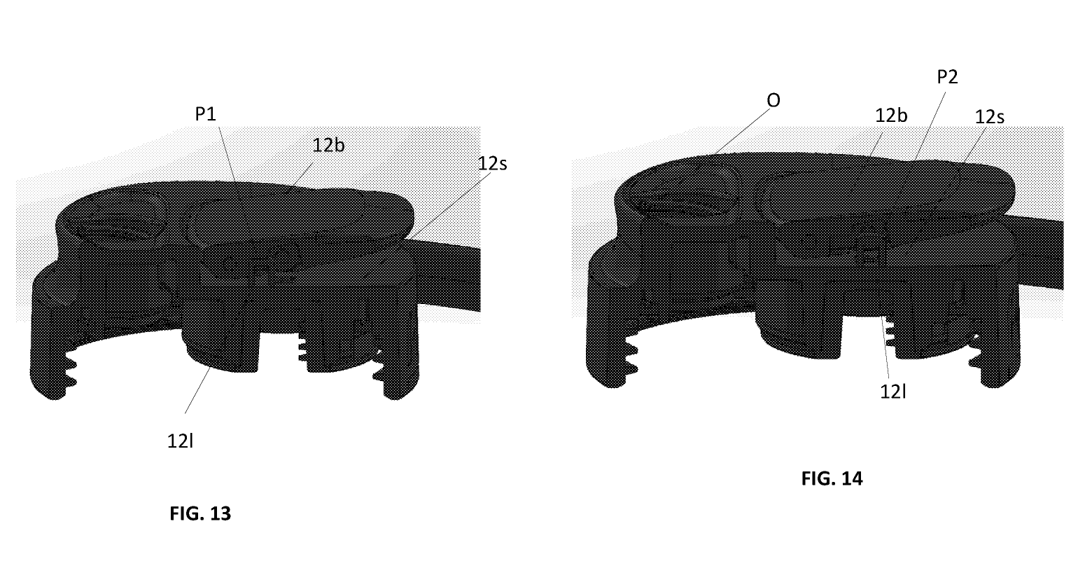

In embodiment, a lock 12l may be provided in the lid 12 as can be seen in FIGS. 13-15. In embodiments, the lock 12l is mounted in the lid 12 under the lever 12b. In a locked position as indicated on FIG. 13, the lock 12l prevents the lever 12b from moving downward. In embodiments, the lock 12l is mounted on a top surface 12s of the lid 12 and slides horizontally from the locked position P1 (shown in FIG. 13, under the lever 12b) to an unlocked position P2 (shown in FIG. 14) where it does not affect movement of the lever 12b. In the locked position, the lock 12l is in contact with a bottom surface of the lever 12b and prevents it from moving lower as illustrated in FIG. 13 to prevent the cartridge from releasing gas.

In embodiments, the lid 12 may also include a flavor element operable to add flavoring to the liquid in the container body. In embodiments, an amount of carbonation provided to the liquid may be adjusted.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A beverage container comprising:
a container portion including a hollow body configured to receive a beverage and including an open top;
a lid removably secured to the open top of the container portion;
the lid including:
a drink opening formed in a top surface thereof and in fluid communication with the hollow body;
a pressure relief valve mounted in the lid and configured to vent pressure when a pressure in the hollow body exceeds a threshold;
a cartridge portion extending downward from the lid into the container, the cartridge portion including a cartridge including a compressed gas;
a lever pivotally mounted on a top surface of the lid movable about a pivot pin from a raised position to a lowered position, such that the cartridge is moved downward when the lever is pivoted to the lowered position,
wherein the cartridge portion further comprises:
a first valve in contact with a bottom of the cartridge including a fixed element that engages a bottom end of the cartridge to release compressed gas from the cartridge as the cartridge is moved down by the plunger; and
a second valve positioned downstream from the first valve configured to selectively release compressed air into the container from the first valve to pressurize the hollow chamber.

2. The beverage container of claim 1, wherein the pressure relief valve is movably mounted in the drink opening to prevent drinking in a closed position and movable to an open position, removed from the drink opening, when in an open position.

3. The beverage container of claim 2, wherein the pressure relief valve further comprises:
a base with a first opening formed in a bottom surface thereof and in fluid communication with the hollow body;
a movable element mounted in the base and movable from a sealed position where the movable element closes the first opening to an unsealed position where the movable element allows air to move from the hollow portion into the pressure relief valve;
a second opening formed is an upper portion of the base in fluid communication with an exterior such that gas from the hollow chamber that enters the first opening exits the pressure relief valve;
wherein the movable member is biased into a sealed position and the movable member moves upward to allow gas to exit the container when a pressure in the hollow chamber exceeds a threshold; and
a third set of threads formed on an outer surface of a lower portion of base configured to secure the pressure relief valve in the drink opening in the closed position and to remove the pressure relief valve from the drink opening when in the open position.

4. The beverage container of claim 1, wherein the lever is operably connected to a plunger that contacts the cartridge to push the cartridge down when the lever is pivoted to the lowered position.

5. The beverage container of claim 1, wherein the lid includes a first set of threads provided on an inner surface of a peripheral flange that interact with a second set of threads provided on an outer surface of a top portion of the container portion to selectively secure the lid to the container portion when the lever is pivoted to the lowered position.

6. The beverage container of claim 1, wherein the lid includes a movable cover configured to receive the pressure relief valve and movable from a closed position, where the pressure relief valve is positioned in the drinking opening and an open position where the pressure relief valve is removed from the drinking opening.

7. The beverage container of claim 1, wherein the third set of threads include gaps formed in the threads to allow gas to escape from the hollow chamber as the pressure relief valve is removed from the drink opening.

8. The beverage container of claim 7, wherein at least one edge of the third set of threads is rounded.

9. The beverage container of claim 1, wherein the first valve includes:
a support element in contact with the cartridge;
a biasing element configured to bias the support into a raised position, wherein the support element and cartridge move down when the lever is depressed.

10. The beverage container of claim 9, wherein the fixed element is mounted in the support element such that the fixed element is in contact with a cartridge valve provided in the cartridge.

11. The beverage container of claim 10, further comprising a flow path formed in the fixed element configured to provide gas from the cartridge to the second valve.

12. The beverage container of claim 11, further comprising a manifold provided downstream of the flow path configured to receive compressed air from the cartridge.

13. The beverage container of claim 1, wherein the second valve includes a hollow post provided at a bottom portion thereof including openings formed in a sidewall thereof and a cylindrical flexible seal covering the openings formed in the sidewall,
wherein the seal cylindrical seal flexes outward to allow gas to exit the second valve when pressure in the post exceeds a threshold.

14. The beverage container of claim 13, wherein the cylindrical seal is made of silicone.

15. The beverage container of claim 1, further comprising a handle pivotally attached to the lid.

16. The beverage container of claim 1, wherein the second valve is a ball valve.

17. The beverage container of claim 1, wherein the pressure relief valve includes a first seal provided at a bottom of the base preventing air from passing between the base and the drink opening.

18. The beverage container of claim 17, the pressure relief valve includes a second seal preventing gas from passing into a top of the pressure relief valve.

19. A lid for a beverage container comprising:
a drink opening formed in a top surface thereof;
a pressure relief valve removably mounted in the lid and configured to vent gas when a pressure in the container exceeds a threshold;
a cartridge portion extending downward from the lid into the container, the cartridge portion including a cartridge including a compressed gas;
a lever pivotally mounted on a top surface of the lid movable about a pivot pin from a raised position to a lowered position, when the level is pivoted to the lowered position,
wherein the cartridge portion further comprises:
a first valve in contact with a bottom of the cartridge including a fixed element that engages a bottom end of the cartridge to release compressed gas from the cartridge as the cartridge is moved down by the plunger; and
a second valve positioned downstream from the first valve configured to selectively release compressed air into the container from the first valve to pressurize the hollow chamber.

20. The lid of claim 19, wherein the pressure relief valve closes the drink opening to prevent drinking in a closed position and is movable to an open position, removed from the drink opening when in an open position.

21. The lid of claim 20, wherein the pressure relief valve includes:
a base with a first opening formed in a bottom surface thereof and in fluid communication with the hollow body;
a movable element mounted in the base and movable from a sealed position where the movable element closes the first opening to an unsealed position where the movable element allows air to move into the pressure relief valve;
a second opening formed is an upper portion of the base in fluid communication with an exterior such that gas that enters the first opening exits the pressure relief valve;
wherein the movable member is biased into a sealed position and the movable member moves upward to allow gas to exit when a pressure in the hollow chamber exceeds a threshold; and
a third set of threads formed on an outer surface of a lower portion of base configured to secure the pressure relief valve in the drink opening in the closed position and to remove the pressure relief valve from the drink opening when in the open position.

22. The lid of claim 19, wherein the lever is operably connected to a plunger that contacts the cartridge such that the cartridge is moved downward when the lever is pivoted into the lowered position.

23. The lid of claim 19, wherein the lid includes a movable cover configured to receive the pressure relief valve and movable from a closed position, where the pressure relief valve is positioned in the drinking opening and an open position where the pressure relief valve is removed from the drinking opening.

24. The lid of claim 19, wherein the third set of threads include gaps formed in the threads to allow gas to escape from the hollow chamber as the pressure relief valve is removed from the drink opening.

25. The lid of claim 19 wherein at least one edge of the third set of threads is rounded.

26. The lid of claim 19, wherein the first valve includes:
a support element in contact with the cartridge; and
a biasing element configured to bias the support into a raised position, wherein the support element and cartridge move down when the lever is depressed.
